(19) United States
(12) Patent Application Publication
(10) Pub. No.: US 2008/0261638 A1
(43) Pub. Date: Oct. 23, 2008

(54) Direct digital sampling method for radios

(76) Inventors: Sami R. Wahab, Melbourne, FL (US); Donald Mark Haines, Melbourne, FL (US); Constantinos S. Kyriakos, Indian Harbor Beach, FL (US); Anthony Nicotra, Melbourne, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/789,027

(22) Filed: Apr. 23, 2007

(51) Int. Cl. H04B 7/00

(52) U.S. Cl. 455/500

(57) ABSTRACT

A direct digital sampling and synthesis general purpose radio system is disclosed which employs single or multiple receiver and/or transmitter sub-systems that require no analog frequency conversion or translation circuitry. Receiver signal processing is disclosed that describes methods of conditioning and digitizing an entire received RF signal band in which the down conversion, channelization and demodulation are performed digitally. In addition, a method for direct synthesis of transmitter signals is also disclosed where up conversion and carrier modulation is performed digitally. Several mitigation techniques are described which aid in overcoming device limitations as well as overcoming problems created by combining multiple digital transmitters and receivers into a single integrated system. One embodiment of the invention describes an integrated VHF/UHF aircraft NAV/COMM radio system which combines a VHF transmitter with four VHF/UHF receivers all of which require no IF circuitry. This embodiment allows for multiple simultaneous airborne radio services on a single platform such as voice and data communication modes (AM, ACARS, VDLM2, LAAS, etc.) as well as navigational modes such as VOR, ILS, and Marker Beacon. By utilizing direct digital methods, the signal processing burden is moved almost entirely to the digital domain where the processing can be optimized for each signal type and where linearity is guaranteed. Fewer RF components are required which result in less unit to unit variability, lower production costs, and improved reliability.

### BACKGROUND OF THE INVENTION

The invention pertains to Very High Frequency/Ultra High Frequency (VHF/UHF) radio equipment installed on commercial and general aviation aircraft used for air-to-ground, ground-to-air, and air-to-air communication as well as radio navigation and instrument landing. As an example, the invention may combine a VHF transceiver operating on 118.0 MHz to 137.975 MHz, a Localizer/VHF Omni-directional Radio Range (VOR) receiver operating on 108.0 MHz to 117.950 MHz, an Instrument Landing System (ILS) Glide Slope receiver operating on 329.300 MHz to 335.0 MHz, and an ILS Marker Beacon receiver operating on 75.0 MHz into a modular package that may be remotely mounted or integrated with an Electronic Flight Information System (EFIS) chassis. The combination of a VHF transceiver with ILS and VOR receivers is common in the industry and is generally referred to as a NAV/COMM system.

The typical NAV/COMM configuration in the current state of the art is to use a double conversion super-heterodyne architecture. In a typical super-heterodyne receiver, incoming signals are converted to a constant lower frequency, known as an intermediate frequency (IF), before detection. In the conversion process, the super-heterodyne receivers mix a signal from a local oscillator (LO), within the receiver, with all of the incoming signals. In a mixer stage of the receiver, the LO signal multiplies with the incoming signal, producing beat frequencies at both the sum and difference of the LO and input frequencies. The signal at the difference frequency is passed on by tuned circuits, amplified, and then demodulated to recover the original audio signal. The double conversion super-heterodyne architecture may also comprise multiple Automatic Gain Control (AGC) stages to provide wide dynamic ranges while maintaining controlled levels of Inter-modulation Distortion (IMD) through the amplifier and mixer stages. Furthermore, modern implementations of the heterodyne and super-heterodyne receivers may digitize the received signal at some IF stage and perform the remaining conversions, AGC, and demodulation functions digitally.

Double conversion is usually necessary to control in-band spurious responses (i.e., harmonics or signals found outside of the device's assigned channel) produced by the mixers while minimizing the interaction between the multiple receiver bands. Channel selectivity is typically performed by a crystal filter following the second mixer stage. Recovery of the signal modulation is accomplished using a diode detector or quadrature Beat Frequency Oscillator (BFO) circuitry, but in modern implementations is often performed by digital means after digitizing the IF or baseband signal.

The state of the art of most VHF transmitters includes a means of modulating baseband signals onto a fixed frequency first LO, then frequency translating the resulting IF signal up to the Radio Frequency (RF) range. However, newer art super-heterodyne models typically modulate a lower IF signal directly using a digital source and a high-Q bandpass filter. Newer art receivers then frequency translate the signal up to VHF using one or two mixer stages each followed by image-rejection filtering, thus reducing the amount of processing steps. The frequency translation circuits, including a frequency synthesizer and a mixer, are usually shared between transmitter and receiver functions since the radio will operate as a receiver or a transmitter but never both at the same time. The frequency synthesizer is typically a Phase-Locked Loop (PLL) synthesizer with a Voltage Controlled Oscillator (VCO).

Even though double conversion super-heterodyne receiver and transceiver architectures provide suitable performance for many applications, they require a high part count, large circuit area and typically require extensive factory tuning and calibration adjustments. For systems containing multiple receivers, such as a NAV/COMM, sophisticated and costly mechanical enclosures are usually necessary in order to provide proper isolation between the various RF/IF subsystems, while maintaining the overall product size suitable for aircraft use.

Another method in the art is the Direct-Conversion method (sometimes referred to as “Zero-IF”). This technique attempts to directly convert an RF signal to baseband, or a baseband signal to RF, in one step. For receivers, this approach typically consists of a front-end stage using wide bandwidth RF filtering and amplification controlled by a single AGC stage. The AGC stage is followed by a balanced quadrature mixer that downconverts the RF signal directly to baseband. Channel selectivity is accomplished by performing low pass filtering on the mixer output. The LO signal, which drives the downconverting mixer, is tuned to the same frequency as the desired RF channel. The LO signal from this circuit is mixed with the RF input and low pass filtered, to produce a quadrature baseband signal around 0 Hz. The resulting baseband signal will have a small frequency offset representing the difference between the actual RF carrier frequency and the receiver LO frequency, but since this signal is usually processed digitally this frequency offset is easily removed by digital means. Thus, the wanted RF demodulated signals may be obtained immediately as an audio output without further detection, and unwanted signals are left on carriers of the frequency difference between their original carrier and that of the wanted RF signal.

Although the Direct-Conversion method is simpler and requires fewer components to implement than a traditional double conversion super-heterodyne architecture, it is limited in several ways. Because the LO signal is at the same frequency as the received signal, the receiver sensitivity will be poor due to LO signal leakage into the mixer output, and phase noise on the LO which adds directly to the baseband modulation carried on the RF signal. Secondly, short-term clock stability of the LO can be a major factor especially if it is necessary to demodulate phase encoded signals such as M-ary Phase Shift Keying (M-PSK) or other similar modern schemes. Thirdly, adjacent channel interference performance is typically poor due to the limited amount of IMD rejection provided by the mixer. Harmonic images of the modulation from the adjacent channel will interfere with the desired channel limiting the overall dynamic range capability of the system. Fourth, since very strong signals may be present in the wideband RF stage, the level of IMD products interfering at the receiver frequency could be quite high. Finally, the in-phase/quadrature (I/Q) output from the quadrature mixer will contain bias and phase errors due to non-linearity errors in the mixing device. I/Q balancing errors typically vary enough over temperature and from unit to unit to require sophisticated calibration techniques to actively minimize these errors. Newer Direct-Conversion receiver art has had limited success minimizing these deficiencies and are typically targeted for systems that do not require high out-of-band and high in-band interference rejection, which has limited their use in commercial avionics systems.

The art of Direct-Conversion transmitters, on the other hand, has had better success meeting a broader range of system requirements. Since the content and amplitude of the input signal are controlled and well known, the distortion products from the up-converting mixer device can be controlled to whatever level is required. This technique directly modulates a quadrature RF carrier signal (i.e. sin(2πωt) and cos(2πωt) components) with a quadrature baseband signal resulting in a complex modulated signal at the RF carrier frequency. These signals are then summed together to produce the desired real transmitted signal. Typically a narrow bandpass filter follows the summer and the result is then amplified up to the desired power level for transmission.

Effects of LO phase noise are not as significant as in a Direct-Conversion receiver because the baseband modulation can be of sufficient amplitude to overwhelm the undesired phase noise component. Short-term clock stability is still an issue especially for data modes. Bias and phase errors resulting from mismatches and non-linearity in the quadrature mixer can be problematic since these errors tend to vary significantly over temperature and from unit to unit making it difficult to factory align and calibrate. However, the main deficiency of this architecture is the IMD produced by the mixer. Modulation harmonics will interfere with adjacent channels, thus limiting the overall performance of the system or even violating spectral mask requirements.

Direct-Conversion transmitters are typically only used for systems with fixed RF carrier frequencies because it is possible to improve the Adjacent Channel Performance (ACP) by placing a very narrow-band filter at the output; but this limitation renders this approach unusable for systems requiring broad tuning capability and restrictive spectral mask requirements. Therefore, Direct-Conversion transmitters are seldom used or attempted when developing commercial avionics products.

Another method in the art is the Direct Sample method (i.e. sometimes referred to as Direct Digital Conversion or “No-IF”). In the simplest form, this technique attempts to digitize RF signals directly or synthesize RF signals directly using digital methods without the aid of frequency translation hardware. For receivers, the RF circuitry consists of wide-band filtering, low-noise amplification, and an AGC. No frequency synthesizers, VCOs, RF mixers, or crystal filters are required. Channel selectivity and demodulation is performed completely by digital means. A very high speed ADC (analog-to-digital converter) is used to digitize the received RF signal directly. Channel tuning is typically accomplished using a VLSI device that contains a complex numerically controlled oscillator (NCO) and programmable multi-stage decimation filters. The output of this VLSI device is then usually demodulated by a programmable digital signal processor (DSP).

### SUMMARY OF THE INVENTION

The Direct Digital Sample architecture used in the present invention has several advantages over the previous two Direct Conversion methods described. First, the problems of mixer IMD are eliminated since no frequency translation is required. This greatly reduces the impact of cross coupled interference from strong in-band or out-of-band signals. Second, the reduced cross-coupling from adjacent channels specifically improves the ACP. Third, the part count of RF components is reduced even over what is required for the Direct Conversion method. Fewer RF components will mean lower cost, size, weight, and power consumption, as well as significantly less factory alignment and calibration. Since the calibration process and other adjustments are all digital, and in general they do not drift with temperature, they are easier and cheaper to perform. Reliability and mean-time-between-failure (MTBF) are improved due to this part count reduction, and especially due to the reduction in sensitive RF and analog components. Finally, the Direct Sample method has the unique capability of simultaneously receiving and processing multiple channels within the receiver band, which does require duplication of circuitry in the VLSI processor and “baseband” DSP processor, but these are much easier and less expensive to implement than their analog counterpart would be.

The Direct Sample method also has several limitations. Sampling VHF/UHF signals directly places a heavy burden on the ADC device and it is only due to great performance improvements in recent years that this technique is now even viable at VHF frequencies. The sensitivity and dynamic range of the resulting receiver system is mainly governed by the performance of this front-end ADC device. The device needs a high effective number of bits (ENOB) and exceptional spurious free dynamic range (SFDR) to maintain the desired overall dynamic range, and must be capable of operating at very high sample rates to avoid Nyquist digital aliasing effects. Until recent years the expense of such high quality ADC devices would override the cost savings made in the RF section.

Another key specification for such systems is the performance of the clock source for the ADC. Clock phase jitter error will directly affect the dynamic range of the digitizing device especially when under-sampling techniques are applied. A clock which has long-term and short-term stability, high accuracy and low jitter is typically necessary. These types of clocks tend to be expensive at high frequency.

For a system like a NAV/COMM, these problems are further exacerbated by the complexity of integrating multiple receivers and a transmitter each of which occupy different VHF/UHF radio frequency bands and each require different bandwidths and different ADC clocking characteristics. In addition, current Direct Sample VHF transmitters have not been viable for NAV/COMM systems because it has not been possible to meet transmitter spectral mask requirements while providing wide-band tuning capability. For these reasons the state of the art for commercial avionics NAV/COMM systems has remained as double conversion super-heterodyne.

It is an object of the present invention to provide a commercial avionic NAV/COMM system that combines a variety of sub-systems, specifically, a VHF transceiver, a Localizer/VOR receiver, an ILS Glide Slope receiver, and an ILS Marker Beacon receiver. Additionally, the NAV/COMM system also meets or exceeds FAA (Federal Aviation Association) requirements for Part 23/Part 25 aircraft installations as well as FCC 47 CFR (Federal Communications Commission) Part 87 and Part 15 requirements. It should be appreciated that any combination of receivers and or transmitters may be included in the presented NAV/COMM system. It should also be appreciated that the present invention may be applied to general purpose radio applications that utilize the Direct Sample method in a single general radio receiver or transceiver and variations of said method.

It is an object of the present invention to utilize the Direct Sample method for both receiver and transmitter signal processing architectures, although sub-sets of this capability are also addressed. Thus, this invention requires no analog IF/RF circuitry to frequency translate desired signals between RF and baseband. All receivers may be digitized directly in the RF stage and the VHF transmitter signal may be synthesized directly by digital means.

In one embodiment of the invention, two Direct Sample sub-systems, one for dealing with the ILS and VOR receivers (sub-system 1), and another to deal with the VHF transceiver and Marker Beacon receiver (sub-system 2), may be employed. Receiver sub-systems 1 and 2 may each be provided a voltage-controlled clock source, NavClk and ComClk respectively. The sub-system with the VHF transmitter may be provided an additional voltage-controlled clock source, TxClk.

An advantage of multiple sub-systems for a NAV/COMM is that it provides some independence between the navigation and communication functions thus minimizing the possibility of common mode failures. This enhances the utility of the device under failed or partially failed conditions. Another advantage is that the sample clock characteristics can be optimized for the frequency band used by each sub-system rather than compromising performance characteristics in order to use the same clock. It should be appreciated that any number of sub-systems, as well as any combination of components for each sub-system, may be employed. It should also be appreciated that the NavClk, ComClk, and TxClk sources need not be independent. Any number of clock sources may be employed and shared in any way.

In another embodiment of the invention, a method of measuring the frequency of each sub-system clock with respect to a highly accurate reference oscillator (such as a temperature compensated oscillator, TCXO) is employed. This may allow for the calibration of sub-systems by means of channel tuning software. Thus, cheaper less frequency accurate technology may be employed for the sub-system clocks.

In an embodiment of the invention, a method to frequency shift sub-system clock frequencies by more than a channel bandwidth, is employed. An advantage of this technique is that it can actively mitigate in-band spurious signals generated from the various sub-system clock sources. The clock frequency shifting is achieved by “pushing” known clock spurs to an unused adjacent channel, then compensating for this shift by adjusting the digital tuning of components that determine the RF operating frequency. This greatly lessens the mechanical and electrical isolation requirements needed to minimize cross-coupling effects between sub-systems. The spacing between sub-systems can be reduced while not increasing manufacturing costs or device size.

In an embodiment of the invention, a method of coupling an auxiliary dither signal onto a RF receiver input, allowing both of the signals to be digitized simultaneously by a high speed ADC, is employed. The auxiliary dither signal may be an FM modulated carrier with a very low modulation index. The auxiliary dither signal may also occupy only a guard band bandwidth and have amplitude nearly full scale of the ADC input range. Additionally, the auxiliary dither signal may be applied to the receiver signal immediately before an analog-to-digital conversion. Thus, dithering is applied after the last RF filter stage. The advantage of this technique is that the frequency of the dither signal may be significantly offset from the desired signal frequency and therefore easily removed after the ADC by digital processing methods. Therefore, no additional subtracting or filtering circuitry is needed. This technique greatly enhances the linear response of the ADC quantizer by improving factors such as cross modulation performance and spurious free dynamic range.

In another embodiment of the invention, a digital method of coupling an auxiliary dither signal onto the transmitter signal, allowing both of the signals to be digital to analog converted simultaneously by a high speed DAC, is employed. The transmitter auxiliary dither signal may be an FM modulated carrier with a very low modulation index. Since the frequency of the transmitter auxiliary dither signal may be significantly offset from the frequency of the desired signal, or in other words occupy an out-of-band bandwidth, it may have an amplitude nearly full scale of the DAC output device and may be easily removed from the transmitted signal, after the digital-to-analog conversion, by standard analog filtering techniques. The transmitter auxiliary dither signal is easiest to remove if it is generated near DC and only extends high enough in frequency to provide the required dithering effect.

A Very High/Ultra High Frequency (VHF/UHF) radio system and corresponding method, according to an embodiment of the invention may comprise a plurality of VHF/UHF radio sub-systems, at least one sub-system of the plurality of sub-systems may be a receiver or transmitter sub-system. It should also be appreciated that the sub-system may be a power supply, or any other radio component that may produce a frequency or any component a user/designer may have control over. The system may also comprise at least one analog signal processing section integrated in the at least one sub-system, and at least one digital signal processing section integrated in may be employed in a direct digital sampling method.

The system may also comprise a single analog processing section which may simultaneously provide an analog signal processing function for a plurality of digital processing sections, where each digital processing section may be comprised in a respective sub-system. The system may also comprise a single digital processing section to be shared with at least one other sub-system.

The at least one receiver or transmitter sub-system may also comprise an auxiliary signal generator that may add an auxiliary signal to an information signal, prior to the information signal being processed by an analog to digital converter, or a digital to analog converter, respectively. The auxiliary signal may comprise a carrier that is frequency modulated at a low FM modulation index.

The system may also comprise a plurality of clock sources, where at least one clock source may be shifted in frequency in a presence of an expected clock spur at a frequency being processed. Each clock source may also comprise a respective frequency that may be a rational number ratio of each other respective frequency.

A general radio system and corresponding method for use may also be implemented. The radio system may comprise a plurality of sub-systems, where at least one sub-system may be an RF receiver or transmitter. The system may further comprise at least one analog processing section integrated in the at least one RF receiver or transmitter sub-system. The system may also comprise at least one digital processing section integrated in the at least one RF receiver or transmitter sub-system, where both the analog and digital processing sections may be employed in a direct digital sampling method. The system may also comprise a clock shifting monitor that may shift at least one clock source, which may control the at least one sub-system, in a presence of an expected clock spur at a frequency being processed. Each clock source in the radio system may comprise a respect frequency that may be a rational number ratio with each other respective frequency. The radio system may also comprise an auxiliary signal generator that may add an auxiliary signal to an information signal, prior to the information signal being processed in the receiver or transmitter sub-system by a analog to digital converter, or a digital to analog converter, respectively

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an exploded view of the assembled apparatus of one embodiment of the p.c.

FIG. 2 is a block diagram of the receivers and transceiver embodiment of the present invention.

FIG. 3 is a flow chart diagram of the frequency tuning computer program used by the receivers and transceiver of FIG. 2.

### DETAILED DESCRIPTION OF THE OF THE PREFERRED EMBODIMENTS

A description of example embodiments of the invention follows.

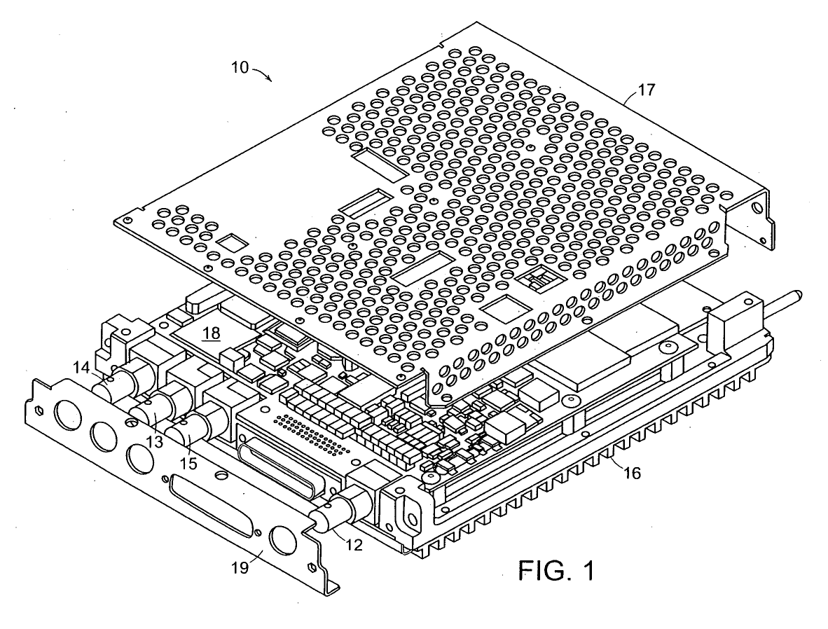

FIG. 1 illustrates a NAV/COMM radio embodiment of the present invention, referred to herein by the general reference numeral 10. The NAV/COMM system 10 comprises an antenna port for a VHF transceiver 12, an antenna port for a Localize/VOR receiver 13, an antenna port for a Glide Slope receiver 14, and an antenna port for a Marker Beacon receiver 15. The NAV/COMM system 10 also comprises circuitry 18 needed to signal process the RF receiver and transceiver signals. The circuitry 18 is enclosed in a chassis consisting of a metal heat-sink backplate 16, an RF shield cover plate 17, and an RF shield front plate 19.

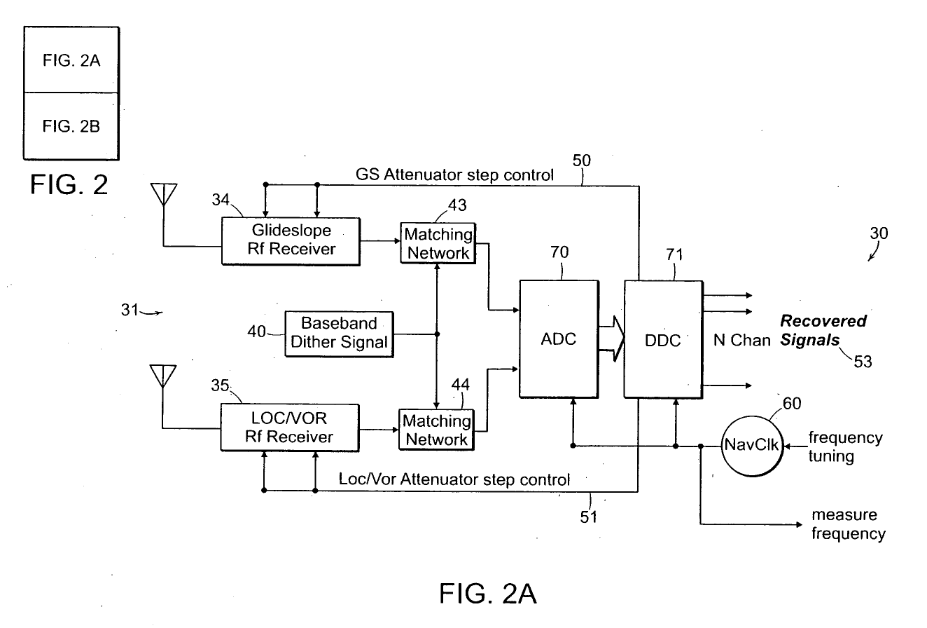

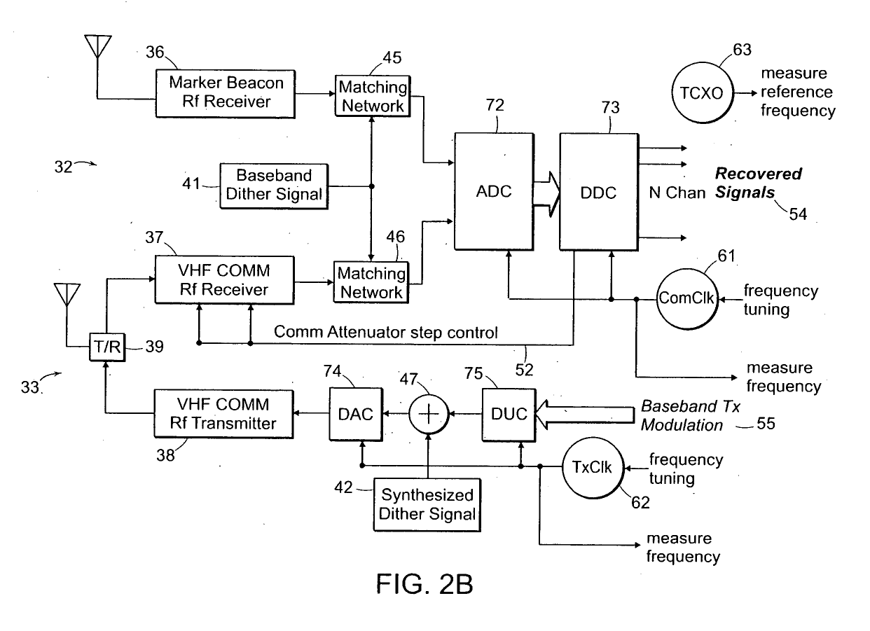

FIG. 2 illustrates an example receiver and transceiver embodiment of the present invention, referred to herein by the general reference numeral 30. It should be appreciated that other receiver and/or transceiver combinations may be employed in the NAV/COMM system. The NAV/COMM receiver and transceiver 30 may comprise two Direct Sample sub-systems, for example, one for processing the ILS and VOR navigation signals 31 and one for processing the VHF communication transceiver and Marker Beacon signals 32. The navigation sub-system 31 may comprise two functional RF receivers, for example, one for processing Localizer/VOR signals 35, which may occupy 108.0 MHz to 117.950 MHz, and one for processing Glide Slope signals 34, which may occupy 329.300 MHz to 335.0 MHz. It should be appreciated that the NAV/COMM system may operate on any RF bandwidth. The Localizer/VOR receiver 35 may comprise low noise amplification and RF filtering to reject only out of band interference, and a step AGC circuit. It should also be appreciated that the sub-systems of the NAV/COMM system may comprise of any number of elements, where the element may be any frequency producing device, and/or any device that may be controlled by a designer or user (i.e., a transmitter, receiver, power supply, etc.).

The step AGC of receiver 35 may be controlled by the discrete attenuator control 51, which may be driven by the Digital-Down-Conversion (DDC) circuit 71. The step AGC may be set to attenuate mode when a digital overflow of the ADC 70 is detected by the DDC 71. The output of the Localizer/VOR receiver 35 may be combined with an auxiliary dither signal 40 using the RF matching network 44. The RF matching network 44 matches the electrical impedance of the transceiver 31 with that of the antenna in order to reduce signal loss.

Many prior art methods employ dithering as a method of delocalizing or randomizing differential non-linearity errors in analog-to-digital or digital-to-analog conversions. Prior dithering systems involve adding an out-of-band dither signal to a received signal prior to undergoing an analog-to-digital conversion. Upon conversion, the dither signal is typically subtracted via additional hardware that must be implemented in the system for this sole purpose.

In contrast, the auxiliary dither signal 40 in this embodiment may be an FM modulated carrier signal with a very low modulation index. The low modulation index reduces the level of FM modulation side-lobes in the frequency range of the desired received signal band. The auxiliary dither signal 40 may be coupled to the receiver input signal 35 by means of the matching network 44. If the auxiliary dither signal 40 is low frequency and the received signal 35 is VHF, the matching network may be a very simple circuit consisting of only a few low cost components. The output of the matching network 44 is then feed to the ADC 70 and converted to digital data.

The ADC 70 may be a dual input, high bit count, ADC device that may be clocked by the voltage controlled crystal oscillator (VCXO) NavClk 60. When the composite signal (Loc/VOR+dither) output from the matching network 44 is quantized by ADC 70, the RF portion of the composite signal (generated from the receiver 35) is digitally folded to occupy the normalized frequency band where the sample rate is at least two times the bandwidth of the intended input signal from 44. For example, if NavClk is 100 MHz and the Loc/VOR signal occupies 108 MHz to 117.950 MHz, then the normalized digitally folded signal would occupy 8 MHz to 17.950 MHz and the auxiliary dither signal would utilize the guardband frequency below 8 MHz. Thus, the dither signal 40 may remain outside the frequency band of interest, even after the ADC 70 has converted the composite signal to digital data.

The data from the ADC 70 may then be passed to the DDC 71. The DDC 71 is also clocked by NavClk 60. In an embodiment of the present invention, the DDC 71 may be an off-the-shelf VLSI component that is designed to extract narrow band signals, from a wide-band input, by utilizing filtering and sample rate down-conversion methods. Thus, the DDC is capable of shifting bandwidth of interest (i.e., the portion of the baseband comprising the digitized signal), while filtering out the dither signal from the digital input signal. Therefore, the dither signal may be removed without the need of additional hardware whose sole purpose is the removal of the dither signal; as the DDC 71 is an electronic component that is common place in receiver technology and whose principle operation is down conversion, not dither removal. Thus, the dither signal may be placed in the data spectrum such that there is enough bandwidth between the dither signal and the desired signal to employ frequency filtering techniques to isolate the signals from each other upon combining the analog signals, and to digitally remove the dither signal from the digital data stream after digital sampling has been performed. The recovered signals 53 from the DDC 71 are then feed to a signal processor for demodulation and further processing. It should be appreciated that the analog processing done in the receiver, matching network, dither signal generator, and the ADC may be defined as a analog processing section. The DDC and any subsequent digital processing performed thereafter may be defined as a digital processing section. The analog and digital processing sections may comprise any number of components known in the art. Additionally, a single analog processing section may provide digital data streams to a plurality of digital processing sections. Also, a number of analog processing sections may share a single digital processing section.

The Glide Slope receiver 34 may comprise a low noise amplification and RF filtering to reject out of band interference, and a step AGC circuit. The step AGC of the receiver 34 may be controlled by the discrete attenuator control 50 which may be driven by the DDC circuit 71. The step AGC may be set to attenuate mode when a digital overflow of the ADC 70 is detected by the DDC 71. The output of the Glide Slope receiver 34 may be combined with an auxiliary dither signal 40 using the RF matching network 43. The output of the matching network 43 may be connected to the second input port of the ADC 70. When the composite signal (Glideslope+dither) output from 43 is quantized by the ADC 70, the RF portion of the composite signal (generated from the receiver 34) may be digitally folded to occupy the normalized frequency band where the sample rate is at least two times the bandwidth of the intended input signal from 43. For example, if NavClk is 100 MHz and the Glideslope signal occupies 329.30 MHz to 335 MHz, then the normalized digitally folded signal would occupy 29.30 MHz to 35 MHz and the dither signal would utilize the guardband frequency below 8 MHz. Thus, the dither signal 40 remains outside the frequency band of interest, even after the ADC 70 has converted the composite signal to digital data. The data from the ADC 70 is passed to the DDC 71 and is digitally down converted. The recovered signals 53 are then feed to a signal processor for demodulation and further processing. For example, ILS signal processing to produce Localizer and Glideslope course deviation signals and audio processing to decode Morse code station identifications.

The communication sub-system 32 may comprise a RF transceiver 33 and a RF receiver for processing the Marker Beacon 36. The RF transceiver 33 may further comprise a VHF COMM receiver 37 operating at, for example, 118.00 MHz to 137.975 MHz, and a VHF COMM transmitter 38 operating at, for example, 118.00 MHz to 137.975 MHz. The RF transceiver 33 may operate as either a receiver or a transmitter, but typically may not operate as both at the same time. A T/R switch 39 may be used to control which component (either the receiver 37 or the transmitter 38) has access to the VHF COMM antenna. It should be appreciated that the components described above are merely an example representation and any combination or number of components may be implemented. For example, the Marker Beacon 36 may be an optional receiver.

The VHF COMM receiver 37 consists of low noise amplification and RF filtering to reject out of band interference, and a step AGC circuit. The step AGC of the receiver 37 may be controlled by the discrete attenuator control 52 which may be driven by the DDC circuit 73. The step AGC may attenuate mode when a digital overflow of the ADC 72 is detected by the DDC 73.

The output of the VHF COMM receiver 37 may be combined with an auxiliary dither signal generated by 41 using the RF matching network 46. The auxiliary dither signal generator 41 is identical to that previously described in 40 except that it is configured to occupy the guardband frequency allocated for the communication sub-system 32. The output of the matching network 46 is connected to an input port of the ADC 72. The ADC block 72 may be a dual input, high bit count, ADC device. It should be appreciated that other ADCs may be implemented in the system.

The output from the matching networks 45 and 46 are connected to the ADC device 72 which may be clocked by VCXO ComClk 61. When the composite signal (VHF Comm Rx+dither) output from the matching network 46 is quantized by the ADC block 72, the RF portion of the composite signal (generated from the receiver 37) may be digitally folded to occupy the normalized frequency band. For example, if ComClk is 100 MHz and the VHF Comm Rx signal occupies 118.0 MHz to 137.975 MHz, then the normalized digitally folded signal would occupy 18.0 MHz to 37.975 MHz and the dither signal would utilize the guardband frequency below 18.0 MHz. Thus, the auxiliary dither signal 41 remains outside the frequency band of interest, even after the ADC block 72 has converted the composite signal to digital data.

The data from the ADC block 72 is then passed to the DDC 73 and digital down converted. The DDC 73 may be identical to the DDC 71 expect it may be programmed differently to support the VHF COMM 37 and/or Marker Beacon 36 input signals. The DDC 73 may also be used to filter out the dither signal, similarly to the operation of the DDC 71. The recovered signals 54 are then feed to a signal processor for demodulation and further processing. For example, audio processing to recover modulation received on multiple VHF COMM channels and feed an output to the pilot's headset or possibly Marker Beacon identification decoding to provide an indication of inner, middle, or outer marker.

The RF transmitter 38 may comprise a two stage power amplifier, wide-band filtering to reject signals outside the pass band, for example, 118 MHz to 137.975 MHz, and additional harmonic filtering just before connection to the T/R switch 39. The input to the transmitter 38 may be complex baseband modulated from a signal processor 55. The transmitter may employ a direct digital signal generation means to create a digital data stream of transmitter signal samples representing the desired modulated transmitter signal. The baseband tx modulation from the processor 55 may feed a digital up converter (DUC) 75 at an audio sample rate, for example, of 8 kHz. The DUC 75 digitally up converts the modulation data to the output sample rate. The output sample rate may be controlled by VCXO TxClk 62.

The DUC 75 may introduce interpolated samples for every real sample from the processor 55. Once the modulation has been up converted to the output sample rate, the DUC 75 may digitally mix the modulation with a complex NCO to produce a modulated carrier signal at the designed transmit frequency. The output from the DUC 75 may then be digital summed with a synthesized auxiliary dither signal 42, whose amplitude is nearly full scale. The synthesized dither signal 42 is an FM modulated carrier with a low modulation index. The low modulation index reduces the level of FM modulation side-lobes in the frequency range of the desired transmitter band.

The result form, via the adder component 47, is feed to the DAC 74 for conversion to the analog domain. The DAC 74 may be clocked by the VCXO TxClk 62. The output from the DAC 74 will be the desired low level analog RF signal modulated with data from the processor 55, plus undesired harmonic and inter-modulation products. The output from the DAC 74 is then applied to the transmitter 38. The largest products may generally be out of band and may be filtered out by the transmitter 38 prior to being amplified. The transmitter 38 may also be used to filter out the dither signal from the RF signal to be transmitted. The level for most in-band products are minimized due to the mixing of the dither signal and the desired RF signal. When transmitting the T/R switch 39 may connect the transmitter 38 to the antenna.

The Marker Beacon receiver 36 may comprise low noise amplification and RF filtering to reject out of band interference. A step AGC is typically not required for this input. The output of the receiver 36 may be combined with an auxiliary dither signal 41 using the RF matching network 45. The output of the matching network 45 is connected to the ADC block 72. When the composite signal (Marker Beacon+dither) output from the matching network 45 is quantized by the ADC block 72, the RF portion of the composite signal (generated from the receiver 36) may be digitally folded to occupy the normalized frequency band. For example, if ComClk is 100 MHz and the Marker Beacon signal is 75 MHz, then the normalized digitally folded signal would be 25 MHz and the dither signal would utilize the guardband frequency below 18.0 MHz. Thus, the auxiliary dither signal 41 remains outside the frequency band of interest, even after the ADC 72 has converted the composite signal to digital data. The data from the ADC 72 is passed to the DDC 73 and digitally down converted. Similarly to the DDC 71, the DDC 73 may also be used to filter out the dither signal from the desired digital signal. The recovered signals 54 may then be feed to a signal processor for demodulation and further processing.

Tuning of the receivers may be accomplished by programming the DDC devices 71 and 73. Tuning of the transmitter may be accomplished by programming the DUC 75. The frequency of the three VCXO clocks, 60, 61 and 62, may be calibrated by measuring the current frequency of each device against a stable reference TCXO 63.

The nominal sample rate of each sub-system may be determined by satisfying the following equations:

$${F}_{s} \approx 4 \frac{{F}_{center}}{2 n + 1} , \\ and$$

$${F}_{s} > 2 BW$$

where≈means “approximately equal to,” Fₛ is the nominal sample rate of the sub-system, F_{center} is the center frequency determined by the TCXO 63, BW is the bandwidth of the operating frequency band, and n is an integer. Here, n is an unknown variable. A sample set of nominal frequencies Fₛ may be determined by varying the value of n. This criterion defines the set of “best guess” sample rates that may be used by a sub-system. With the set of “best guess” sample rates, the lowest possible sample rate may be determined, as well as the hardware parts necessary to achieve this sample rate. Other system parameters such as clock phase noise, guard band bandwidths, quarter clock spurs, etc, may also be properly evaluated when picking sample rates.

The nominal clock frequencies of each sub-system may be related such that the ratio of clock frequencies can be expressed as a ratio of integers. In mathematics a ratio of two integers is referred to as a rational number. For example if ComClk is 40 MHz and NavClk is 60 MHz, then the clocks are numerically related by a ratio of ⅔ and this ratio represents a rational number. The purpose of this clock selection methodology is to optimize the distribution of spurious components generated by the clock sources. Given the embodiment described here within, the three clock sources, NavClk, ComClk, and TxClk, may be related by a rational number ratio such that the criteria of the following set of equations are met:

n₁·NavClkFs=n₂·ComClkFs

n₃·NavClkFs=n₄·TxClkFs

n₅·ComClkFs=n₆·TxClkFs

where n₁ to n₆ are non-zero integers, NavClkFs represents the nominal sample rate in Hz of the NAV sub-system, ComClkFs represents the nominal sample rate in Hz of the receiver portion of the COMM sub-system, and TxClkFs represents the nominal sample rate in Hz of the transmitter portion of the COMM sub-system. By varying the values of n₁-n₆, a set of sample rates for the NAV, COMM, and transmitter portion of the COMM sub-systems may be determined.

In an embodiment of the present invention, TCXO 63 is a highly accurate temperature-compensated oscillator. Measurement of the VCXO clocks 60, 61 and 62, may be accomplished by counting the number of clock cycles within a defined time period. The time period or “gate time” may be generated from the reference TCXO 63. It should be appreciated that the three clock sources, NavClk, ComClk, and TxClk need not necessary be independent clock sources. For example, a single clock source may be used, wherein each sub-system may use a fraction of the single clock source. Thus, it may be feasible to replace the two receiver clocks 60, 61, NavClk and ComClk, with a TxClk/2 source. A simple flip-flop with a clock driver would suffice for this example. It is not the specific clock frequencies which matter but the techniques that are deployed by this invention to improve quantizer linearization and to mitigate receiver interference by known clock spurs.

Two modes may be used, one for maintaining currently tuned frequency accuracy, and one for re-calculating parameters when the VCXO clock frequency(ies) need to be pulled to avoid known clock spurs. With respect to the first mode of operation, the apparent operating frequency of the receiver or transmitter may be reset to compensate for the induced error in the digital clocks 60-62. With respect to the second mode of operation, in the case of a clock spur, the tuning circuitry may be used to offset the digital clock frequency by at least the bandwidth of a channel being received by the sub-system receiver or transmitter, in order to shift the clock spur out of the bandwidth of interest.

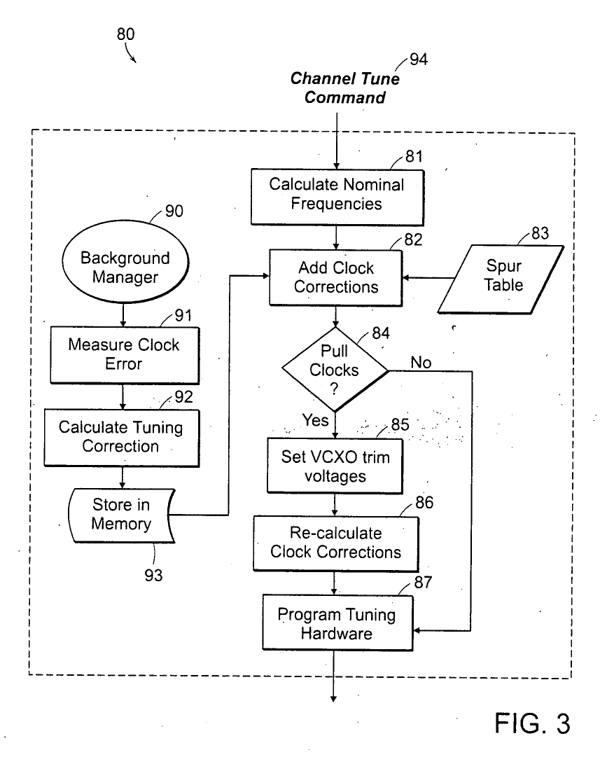

FIG. 3 illustrates a flow chart diagram of the frequency tuning computer program used by the receivers and transceiver in the present invention, referred to herein by the general reference numeral 80. During normal operations, a software background task 90 may periodically monitor the accuracy of the VCXO clocks, 60, 61 and 62. For example, every second, a measurement of the clock errors may be made 91. New tuning corrections may be calculated 92 and stored to memory 93 for use later by the tuning algorithm. When a tuning command occurs 94, for example by a pilot selecting or tuning in to one of the bandwidths received by a receiver of the system 30, the message is decoded to extract the desired nominal frequencies 81. Clock error adjustments stored by 93 are added to the nominal frequencies 82. Once the actual desired frequencies are known, a look-up table 83 is scanned for known interfering clock spurs. If no spurs fall in any of the desired channels 84, then the tuning hardware is immediately updated 87 with the new frequencies. If a spur does fall on a desired channel 84, the VCXO clock trim voltages are re-set 85 such that the interfering clock spur is pushed to an un-used adjacent channel, thus the known clock spur is shifted out of the bandwidth of interest. When the trim voltages are updated, it may change the frequencies of the VCXO clocks. Clock corrections may then be re-calculated 86 using a shortened gate time of a few hundred milliseconds. Finally, the tuning hardware may be updated 87 with the new frequency data.

While this invention has been particularly shown and described with references to example embodiments thereof, it will be understood by those skilled in the art that various changes in form and details may be made therein without departing from the scope of the invention encompassed by the appended claims.

What is claimed is:

1. A Very High/Ultra High Frequency (VHF/UHF) Aeronautical band radio system comprising:
a plurality of VHF/UHF radio sub-systems, at least one sub-system of the plurality of sub-systems is a receiver or transmitter sub-system;
at least one analog signal processing section integrated in the at least one sub-system; and
at least one digital signal processing section integrated in the at least one sub-system, with both the analog and digital processing sections being employed in a direct digital sampling method.

2. The system of claim 1 wherein a single analog processing section simultaneously provides an analog signal processing function for a plurality of digital processing sections, each digital processing section comprised in a respective sub-system.

3. The system of claim 1 wherein the at least one sub-system comprises a single digital processing section to be shared with at least one other sub-system.

4. The system of claim 1 wherein the at least one receiver or transmitter sub-system further comprises an auxiliary signal generator that adds an auxiliary signal to an information signal, prior to the information signal being processed by a analog to digital converter, or a digital to analog converter, respectively.

5. The system of claim 4 wherein the auxiliary signal comprises a carrier that is frequency modulated at a low FM modulation index.

6. The system of claim 1 wherein the plurality of sub-systems are controlled by a plurality of clock sources, with at least one clock source being shifted in frequency in a presence of an expected clock spur at a frequency being processed.

7. The system of claim 6 wherein the at least one receiver or transmitter sub-system further comprises an auxiliary signal generator that adds an auxiliary signal to an information signal, prior to the information signal being processed by a analog to digital converter, or a digital to analog converter, respectively.

8. The system of claim 7 wherein the auxiliary signal comprises a carrier that is frequency modulated at a low FM modulation index.

9. The system of claim 8 wherein each clock source of the plurality of clock sources comprises a respective frequency that is a rational number ratio of each other respective frequency.

10. The system of claim 1 wherein each clock source of the plurality of clock sources comprises a respective frequency that is a rational number ratio of each other respective frequency.

11. The system of claim 10 wherein the at least one receiver or transmitter sub-system further comprises an auxiliary signal generator that adds an auxiliary signal to an information signal, prior to the information signal being processed by a analog to digital converter, or a digital to analog converter, respectively.

12. The system of claim 11 wherein the auxiliary signal comprises a carrier that is frequency modulated at a low FM modulation index.

13. A method of processing comprising:
processing an analog radio frequency signal on at least one Very High/Ultra High Frequency (VHF/UHF) sub-system;
processing a digital data stream on the at least one VHF/UHF aircraft band sub-system; and
using a direct digital sampling method to directly convert the digital data stream into the analog radio frequency signal, or to directly convert the analog radio frequency signal into the digital data stream.

14. The method of claim 13 further comprising simultaneously providing an analog signal processing function for a plurality of digital processing sections, with each digital processing section comprised in a respective sub-system.

15. The method of claim 13 further comprising sharing a digital processing section in the at least one VHF/UHF sub-system with at least one other VHF/UHF sub-system.

16. The method of claim 13 further comprising adding an auxiliary signal to an information signal, prior to the information signal undergoing a analog to digital conversion, or a digital to analog conversion.

17. The method of claim 16 further comprising modulating a carrier in the auxiliary signal at a low FM modulation index.

18. The method of claim 13 further comprising controlling the digital and analog processing with a plurality of clock sources, at least one clock source being frequency shifted in a presence of an expected clock spur at a frequency being processed.

19. The method of claim 18 further comprising adding an auxiliary signal to an information signal, prior to the information signal undergoing a analog to digital conversion, or a digital to analog conversion.

20. The method of claim 19 further comprising modulating a carrier in the auxiliary signal at a low FM modulation index.

21. The method of claim 20 further comprising rationally relating a respective frequency of a clock source with each other respective frequency of the plurality of clock sources.

22. The method of claim 13 further comprising rationally relating a respective frequency of a clock source with each other respective frequency of the plurality of clock sources.

23. The method of claim 22 further comprising adding an auxiliary signal to an information signal, prior to the information signal undergoing a analog to digital conversion, or a digital to analog conversion.

24. The method of claim 23 further comprising modulating a carrier in the auxiliary signal at a low FM modulation index.

25. A radio system comprising a plurality of sub-systems, with at least one sub-system being an RF receiver or transmitter, the system further comprising:
at least one analog processing section integrated in the at least one RF receiver or transmitter sub-system;
at least one digital processing section integrated in the at least one RF receiver or transmitter sub-system, both the analog and digital processing sections being employed in a direct digital sampling method; and
a clock shifting monitor shifting the frequency of at least one clock source, controlling the at least one sub-system, in a presence of an expected clock spur at a frequency being processed.

26. The system of claim 25 wherein a single analog processing section simultaneously provides an analog signal processing function for a plurality of digital processing sections, each digital processing section comprised in a respective sub-system.

27. The system of claim 25 wherein the at least one sub-system comprises a single digital processing section to be shared with at least one other sub-system.

28. The system of claim 25 wherein the at least one receiver or transmitter sub-system further comprises an auxiliary signal generator that adds an auxiliary signal, the auxiliary signal comprising a frequency modulated carrier with a low FM index, to an information signal, prior to the information signal being processed by a analog to digital converter, or a digital to analog converter, respectively.

29. The system of claim 28 wherein the at least one clock source comprises a respective frequency that is a rational number ratio of at least one other respective frequency of at least one other clock source.

30. A method for processing comprising:
providing an analog processing function by processing an analog radio frequency signal on at least one radio receiver or transmitter sub-system;
providing a digital processing function by processing a digital data stream on the at least one radio receiver or transmitter sub-system;
using a direct digital sampling method to directly convert the digital data stream into the analog radio frequency signal, or to directly convert the analog radio frequency signal into the digital data stream; and
frequency shifting at least one clock source, controlling the at least one sub-system, in a presence of an expected clock spur at a frequency being processed.

31. The method of claim 30 further comprising simultaneously providing the analog processing, on a single receiver or transmitter sub-system, for a plurality of receiver or transmitter sub-systems.

32. The method of claim 30 further comprising sharing the digital processing function of the at least one receiver or transmitter sub-system with at least one other receiver or transmitter sub-system.

33. The method of claim 30 further comprising adding an auxiliary signal, the auxiliary signal comprising a frequency modulated carrier with a low FM index, to an information signal, prior to the information signal undergoing a analog to digital conversion, or a digital to analog conversion.

34. The method of claim 33 further comprising rationally relating a respective frequency of the at least one clock source with at least one other respective frequency of at least one other clock source.

35. A direct digital sampling radio sub-system comprising a plurality of sub-systems, at least one sub-system being a receiver or transmitter, the receiver or transmitter sub-system further comprising:
at least one analog processing section;
at least one digital processing section, both the analog and digital processing sections being integrated in each receiver or transmitter sub-system, and both units employed in a direct digital sampling method; and
at least one clock source, each clock source controlling the analog and digital processing sections of each receiver or transmitter sub-system, and each clock source comprising a respect frequency that is a rational number ratio with each other respective frequency.

36. The system of claim 35 wherein the at least one receiver or transmitter sub-system further comprises an auxiliary signal generator that adds an auxiliary signal to an information signal, prior to the information signal being processed by a analog to digital converter, or a digital to analog converter, respectively.

37. The system of claim 36 wherein the auxiliary signal comprises a carrier that is frequency modulated at a low FM modulation index.

38. The system of claim 37 wherein the at least one clock source is frequency shifted in the presence of an expected clock spur at a frequency being processed.

39. A method of processing comprising:
providing an analog processing function by processing an analog radio frequency signal on at least one radio receiver or transmitter sub-system;
providing a digital processing function by processing a digital data stream on the at least one radio receiver or transmitter sub-system;
using a direct digital sampling method to directly convert the digital data stream into the analog radio frequency signal, or to directly convert the analog radio frequency signal into the digital data stream; and
rationally relating a at least one frequency with at least one other frequency, each frequency being associated with a respective clock source.

40. The method of claim 39 further comprising adding an auxiliary signal to an information signal, prior to the information signal undergoing a analog to digital conversion, or a digital to analog conversion.

41. The method of claim 40 further comprising modulating a carrier in the auxiliary signal at a low FM modulation index.

42. The method of claim 41 further comprising frequency shifting at least one clock source in a presence of an expected clock spur at a frequency being processed.

43. A direct digital sampling radio sub-system comprising a plurality of sub-systems, at least one sub-system being a receiver or transmitter, the receiver or transmitter sub-system further comprising:
at least one analog processing section;
at least one digital processing section, both the analog and digital processing sections being integrated in each receiver or transmitter sub-system, and both units employed in a direct digital sampling method; and
an auxiliary signal generator that adds an auxiliary signal to an information signal, prior to the information signal being processed in the receiver or transmitter sub-system by a analog to digital converter, or a digital to analog converter, respectively.

44. A method for processing comprising:
providing an analog processing function by processing an analog radio frequency signal on at least one radio receiver or transmitter sub-system;
providing a digital processing function by processing a digital data stream on the at least one radio receiver or transmitter sub-system;
using a direct digital sampling method to directly convert the digital data stream into the analog radio frequency signal, or to directly convert the analog radio frequency signal into the digital data stream; and
adding an auxiliary signal, the auxiliary signal comprising a frequency modulated carrier with a low FM index, to an information signal, prior to the information signal undergoing a analog to digital conversion, or a digital to analog conversion.
